(19) United States
(12) Patent Application Publication
(10) Pub. No.: US 2008/0037727 A1
(43) Pub. Date: Feb. 14, 2008

(54) Audio appliance with speech recognition, voice command control, and speech generation

(76) Inventors: Clas Sivertsen, Lilburn, GA (US); James Wang, Duluth, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/485,902

(22) Filed: Jul. 13, 2006

(51) Int. Cl. H04M 11/00

(52) U.S. Cl. 379/88.13

(57) ABSTRACT

Methods and devices provided for an audio appliance system that remotely command and control cell phone and various IT, electronic products through voice interface. The voice interface includes voice recognition, and voice generation functions, thus enables the appliance to process information through voice on cell phones/IT products, streamline the information transmission and exchange. Additionally, the appliance enables convenient command and control of various IT and consumer products through voice operation, enhancing the usability of these products and the reach of human users to the outside world.

### TECHNICAL FIELD

The present invention relates to a unique audio appliance that can be in the form of a voice enabled wireless headset or controller, which is a wireless headset or controller that use voice to remotely command and control cell phones and other IT products, and easily carry on other advanced features such as synchronization, data processing, etc. through voice interaction.

### BACKGROUND

The functionalities and user-friendliness of current audio appliances available in the market are very limited. The current appliances tend to rely on different keypads to operate features on, while it is hard for users to get used to the operation procedure and interface. Plus, each appliance operate individually and it is hard to have a convenient unified command and control.

There are certain audio appliances such as wireless headsets currently available to facilitate users when receiving or making calls on cell phones, mostly nowadays in the form of Bluetooth headsets. While it alleviates the needs of wires connecting the cell phone/other IT products, it has big application limitations. First, it can only execute simple phone calls on the headset; second, it is hard for user to command/control, hard to find information from it, and hard to conduct advanced application and features.

For example, a user need to first wear this available headset on the ear, but since it only has one button for its operation, the user will fumble hard to try to click the right times to get the specific feature he/she want.

After clicking properly to wirelessly communicate with cell phones, user now need to click proper times to get to receive/hang up call feature, or a three-way call feature. Besides, it is impossible to find out the caller information from the headset, let alone easy command/control and other advanced application including dictating messages directly through headset etc.

Thus a new technology and appliance product that can operate easily with powerful command/control is greatly needed. Through this technology and its appliance product, cell phones and other IT products will be efficiently and centrally operated through voice interaction.

### SUMMARY OF THE INVENTION

Embodiments of the present invention address these problems and others by providing voice command/controlled wireless headsets or controllers which operate through convenient voice recognition processing. Thus, a user can activate the connection between the embodiment and the cell phone or other IT products through voice recognition, and voice command/control the operation of the cell phones, and other IT products, which can include computers, PDAs, pagers, other electronic devices. In another perspective, the invention embodiment headset also becomes a one-for-all smart remote controller/operator, simplifies the operation of IT products through voice interface.

Specifically for cell phone application, by utilizing the embodiment headset, user not only can receive and make phone calls through easy voice alert or voice dialing relatively, but can also voice command three way conference, voice calendar, voice text/email, i.e., dictate messages through voice to the headset and consequently to the cell phone and sending, together with other advanced voice application features. And the difficulty of operating various features on current headset through clicking on the only one button is conveniently resolved through advanced voice interface command/control

The embodiment of this invention contains the necessary hardware, software and firmware to receive audible speech, and process this speech into commands, translating the speech, or taking specific actions based on this speech. On the other side, this embodiment also receives text and other data, and accordingly transforms the information into voice signal, and sends this speech information back to user. The embodiment has the capability to receive and transmit audio through a wireless protocol, such as but not limited to Bluetooth or WiFi, to various IT products, with the text to speech and speech to text transformation, and consequently enabling easy command and control of IT products and other operations.

These and various other features as well as advantages, which characterize the present invention, will be apparent from a reading of the following detailed description and a review of the associated drawings.

### DESCRIPTION OF THE DRAWINGS

FIG. 1a is a view of the invention contained in an enclosure and connected through a cable to an interaction device, in this case a cell-phone. This connection is typically a serial-port connection.

FIG. 1b is a view of the invention contained in an enclosure and connected through a cable to an interaction device, in this case a Personal Data Assistant (PDA). This connection is typically a serial-port or USB connection.

FIG. 1c is a view of the invention contained in an enclosure and connected through a cable to an interaction device, in this case a Personal Computer (PC). This connection is typically a serial-port connection, USB or FireWire.

FIG. 2 shows the typical application of the invention, where it receives voice commands from a human, gives commands and data to an interaction device, and passes audible speech back to the human.

FIG. 3 is a flow diagram for the typical processing of a received voice command, through its processing and termination.

FIG. 4 shows the hardware architecture, which is centered around the CPU with added functions as peripherals. The Audio in (microphone or line input), selectable through a multiplexer (mux), provides an analog waveform from speech, and is processed by an analog-to-digital converter (ADC) into digital data which the processor can receive. The Audio Output is generated by the CPU using the digital-to-analog converter (DAC) and is provided to the audio multiplexer (mux), which sends the audio to a local speaker or a head-set plug. Also, the CPU has serial port(s), a Bluetooth interface, Random Access Memory (RAM) and Flash for storing the OS, application, and file system.

FIG. 5 shows the software architecture, which consists of several layers in term of their functionalities. The top layer is the audio input/output driver, which is the data communication interface with the hardware. Audio input driver transfers the audio input data from the hardware to the application layer while audio output driver sends the audio output data to the hardware from the application layer. The application layer implements the business logic driven by the audio data and communicates with the speech engine for audio data recognition and composition. The Operating System (OS) communication layer acts as the proxy for the underlying OS (kernel). It delegates the system calls from the application layer to the kernel and returns the results of those calls back to the application layer from the kernel.

FIG. 6 shows an illustration of the device when implemented with a pushbutton to control exact sampling of voice data, to trigger specific functions and to save device power during periods when the device does not need to sample incoming audio.

### DETAILED DESCRIPTION

Embodiments described herein facilitate the apparatus and systems for providing voice commands to an interaction device, such as a cell phone, a personal data assistant (PDA), a personal computer (PC), a laptop, or other similar system. In the following detailed description, references are made to the accompanying drawings that form a part hereof, and in which are shown by illustrating specific embodiments or examples. The Audio Appliance is from now on referred to as “device” for simplicity. The device is shown in the figures as a “white box” or a “block”. The actual physical implementation of the device would comprise of one or more printed circuit boards with components necessary to realize the desired function. The device may contain a battery or super-capacitor to power the on-board circuitry, and or have a power/charging connector available externally. Since the device might be particularly small, multiple interfaces may be implemented through a single or a few connectors rather than having individual connectors for each interface. The device contains both an audio input and audio output. The audio input may be realized as a built in microphone or as a line input from an audio source, such as an external microphone, a headset or i.e. a car hands-free system. The audio output may be realized as a built in amplifier with a built in speaker, or as a line output for connection to an external component, such as a head-set, an ear-piece, an external speaker, a car hands-free system, or similar.

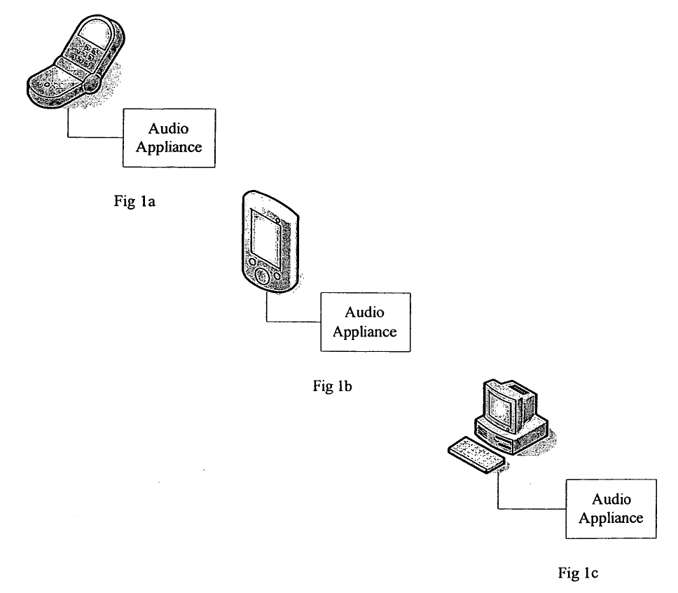

FIGS. 1a, 1b and 1c shows various applications of the device, when connected to some examples of interaction devices. FIG. 1a shows the device when connected to a cellular telephone, in which case the device can send and receive serial data streams to and from the cell phone to receive information and send information. The kind of information exchanged with the cell phone could be but are not limited to; control commands to turn the cell phone on or off, enable/disable features in the cell phone, report incoming calls, respond to how to handle calls, pick-up calls, terminate calls, etc. This interface could also be used as an extension of the cell-phone keyboard, so that commands to push buttons on the cell phone could be done through the device. This would be particularly useful when dictating text-messages or e-mails. The device may also be connected to audio-ports of the cell phone, so that the microphone of the cell-phone could be used as input for the speech recognition function. Another very useful feature of this device would be to read and write address book data of the cellular phone, which is used to store name, number, address, email-addresses, etc as data records in the phone SIM-card or flash memory. The device could then store a copy of the address-book data records in its own memory. The user could then connect the device to another cell phone and add or overwrite the address book in that interaction device. This would make the device serve as a backup-device for the address book information stored in the phone, or simply as a transfer mechanism for data between cell phones. With the speech recognition capabilities of the device, one application of the device would be a phone address book back-up device where speech would be used to initiate transfers, backups, erases, overwrites, record replacements etc. rather than pushing buttons.

FIG. 1b shows similarly to FIG. 1a the device connected to a personal data assistant (PDA) serving as the interaction device. In this case, the device would interact with the device to exchange control commands, data address records, or audio. The device would be particularly useful in extending the input capabilities of the interaction device. An example of this would be an application where the user reads audible speech into the device, the device converts the speech into a combination of text and commands, and provides this to the interaction device. This could be used to dictate e-mails, text into a word processor, notes, or control commands to open or close applications, send mail, check e-mails, etc.

Another very useful feature of the device (or audio appliance) would be to translate text into audible speech. For FIGS. 1a and 1b, the device could for example be configured via voice commands to read new e-mails. Then, it would receive the new e-mails as text over the communication port, and then read the e-mails to the user as audible speech through the internal speaker or line-output. This would be particularly useful for applications such as hands free operation in a car, for disabled people and for operations where the user is not physically looking at the screen of the interaction device, and is using the device as a communications means between the device and the interaction device.

FIG. 1c shows the connection of the device to a personal computer, which extends a super-set of the functions described for FIGS. 1a and 1b, and includes additional set-up information for the device, debugging, configuration, transfer of upgrades to the device, or charging through the USB port.

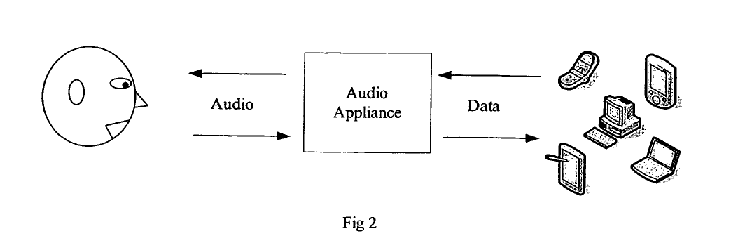

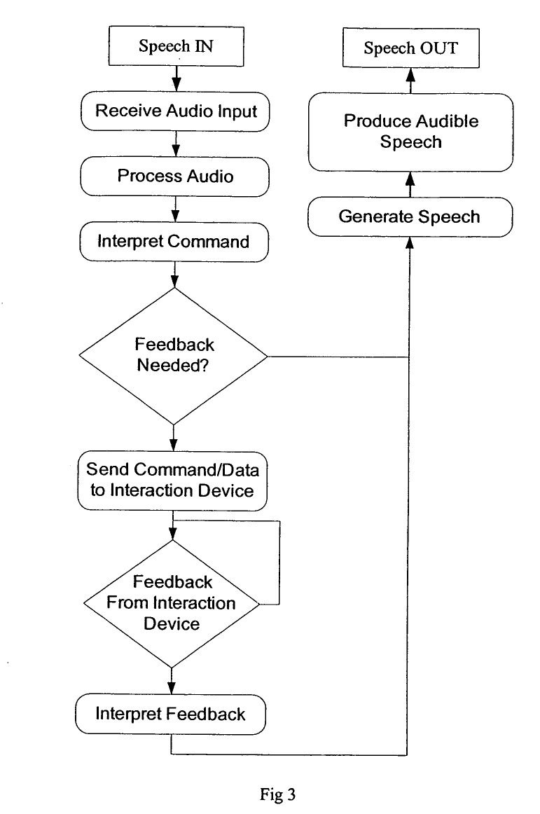

FIG. 2 shows a typical user model of the device, where a human speaks commands into the device's audio input, the device then processes the audio and transfers it to one or more interaction devices. The device then can receive feedback from the interaction device and provide audible speech back to the human. One example of using the device in this way in particular would be where a human instructs the device to make a phone call to a person using their name. This is illustrated in FIG. 3. Following the flow-diagram from top to bottom, the device would then receive the text input, in this case a command followed by data (the name) and process the received audio into command and text. Then, the device would send instructions to the phone to dial the number of the person. During the process, the device can provide audible feedback to the human of the progress and status of the process.

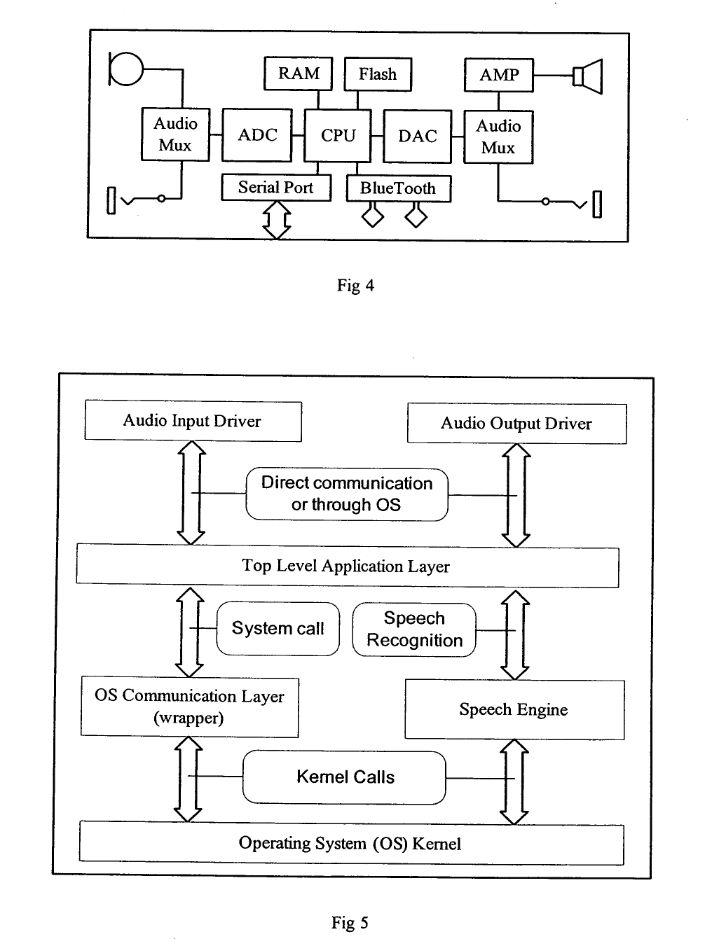

FIG. 4 shows the hardware architecture of the device. Audio is received in the internal microphone or externally from a line input. The audio is then sampled into digital audio data by the ADC. Alternatively a codec could be used, which will also additionally process the audio after receiving it. The Central Processing Unit (CPU) boots and runs out of the flash-ROM (Read Only Memory). Random Access Memory (RAM) is used for temporary storage of variables, buffers, and run-time code, etc. The CPU communicates directly with external devices through a serial port or through the Bluetooth wireless interface. The CPU can produce audible audio output through the DAC. Alternatively a codec can be used in place of the DAC. An audio codec could be used to replace the functionality of the ADC and the DAC, besides adding simple audio processing algorithms. Audio Multiplexers are used in this application simply as an electronically controlled audio switch.

FIG. 5 shows the software architecture of the device. The core functions of the devices, timers, processes, threads, interrupts, etc. are handled by the Operating System Kernel. The OS used could be a version of the Linux operating system targeted for an embedded device. An Application runs on the device, which is the main program that receives and handles the input/output, starts the generation of an audio-stream, starts the interpretation of raw incoming audio data into commands, sends and receives serial and Bluetooth data, and other housekeeping functions. The speech recognition and speech engines are also applications and services that is called by the main application to process data.

The specific operation and internal working of the operating system is not unique for this device, and is not critical for its operation. The uniqueness of this device is in the features, peripherals, and functions it performs, and the Operating System Architecture is given for reference only.

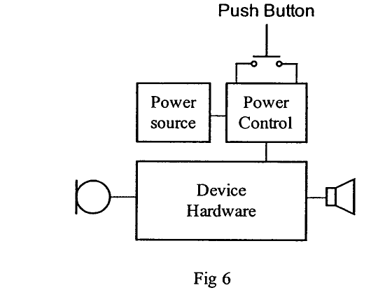

FIG. 6 shows an optional, but very important feature of the device; a momentary switch maybe located on the device. This switch may serve several operations. It is possible for the product to support a multitude of these operations, but allow the end user to configure specifically which operations the switch is desired to operate. A specific function of this switch may be for the device to normally be in a low power state, where power consumption is substantially reduced to a minimum, depending on the configuration the device may or may not be powered at all, or only specific parts of the device may be powered. When the switch is pressed, the device quickly “wakes-up” and starts recording a voice input. When the button is released, the incoming sampling stops and conversion and processing of the received audio is initiated. After the required processing is completed, and the required responses given, the device again enters the low power mode.

Another likely useful application for this device is for embedding into remote control devices. Examples of such implementations would be a traditional hand-held TV/VCR/DVD remote control that with this device embedded or added would add speech command capabilities to the remote control. Other devices would be remotes for car-doors, controls for home automation lighting and audio/video.

For the medical industry this device would be particularly useful for applications where medical personnel traditionally would be required to push buttons for set-up, start/stop, read measurements, etc on medical appliances. With this device embedded or added, the medical apparatus would be controlled via voice commands, and thus allow the use of the device in a hands-free mode. This also improves sanitary conditions, where medical personnel no longer have to physically touch the device, which could transmit bacteria, dirt or fluids.

This device also has very advantageous applications when embedded in Global Positioning (GPS) and navigation systems. In this case, adding this device to send and receive voice commands would great improve convenience and safety, but avoiding the driver/operator having to physically interact with the interaction device's screen and buttons, but rather use voice commands to communicate with it.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

What is claimed is:

1. An apparatus for receiving human speech as audio input through a microphone or through an audio accessory that processes the received audio into text and receives text that it processes into audible speech comprising:
an audio receiver portion implemented either as an analog to digital converter or as an audio encoder or as part of a codec; and
a central processing unit that runs the operating system and applications necessary to implement the desired functions; and
an audio output portion implemented either as a digital to analog converter or and an audio decoder or as part of a codec that is capable of generating audible sound recognized by a human as speech based on text input.

2. An apparatus according to claim 1 with a serial port that connects to a cellular phone, and that can communicate commands for controlling the phone power, navigate menus, dial numbers, answer and terminate calls, receive address book information, containing names, numbers, addresses, e-mail addresses, and additional data stored for each record, store address book information, containing the same information.

3. An apparatus as described in claim 2 where the device is a Personal Digital Assistant (PDA), Personal Computer (PC), or a Portable Media Player (PMP).

4. An apparatus as described in claim 1 where the addition of the apparatus described herein enables a device to receive voice commands from a human operator, allowing the operator to control, configure or enable/disable functions of the apparatus without having to interact with the device through buttons.

5. An apparatus as described in claim 4 particularly used in the medical industry, such as but not limited to emergency room equipment, blood and glucose monitors, heart monitors, equipment used to assist in surgery, temperature and blood pressure monitor devices, any electronic medical device requiring interaction from an operator, and in the emergency medical response industry such as in ambulances, fire trucks, and dispatch operators such as but not limited to locating devices, map and tracking devices, traffic speed monitoring devices, equipment for accessing law enforcement databases, and other communication devices.

6. An apparatus as described in claim 4 particularly used in the transportation industry such as but not limited to cargo tracking devices, global positioning equipment, dispatch of personnel and services.

7. An apparatus as described in claim 4 particularly used in the law enforcement such as but not limited to traffic speed monitoring devices, equipment for accessing law enforcement databases, and communication devices.

8. An apparatus as described in claim 4 particularly used in the office administration and documentation such as but not limited to, computers, printers, fax management, message information management, documentation dictation and preparation, unified message system, information reading by voice generation, devices used to store voice messages, reminders, appointments, etc. where data is read in as speech, converted to text, stored as text and read back as speech.

9. An apparatus as described in claim 4 where the application is used in military, defense-systems, aerospace, or outer space equipment to add speech recognition or generation features to an existing device.

10. An apparatus as described in claim 4 specifically used in a home automation product or accessory for controlling lights, security, audio level, audio selection, video channel, video channel selection, lighting theme, sprinklers, pool, spa or water feature controls where the device receives audible speech from an operator, processes the speech into commands or data that passes to the controlling device.

11. An apparatus from claim 10 where adding the apparatus adds capability to device to provide status, data, level, or condition feedback to an operator in the form of human like speech, such as but not limited to automobile maintenance indicator, temperature, oil, gas or speed gauge.

12. An apparatus as described in claim 4 used particularly for ATM machines, cash terminals, card readers, payment and automated checkout stations, devices for blind or vision impaired people.

13. An apparatus as described in claim 4 when used particularly in devices for sports such as golf, bicycling, motorcycling, etc where the user can be provided information through audible speech, thus avoiding having to look at a screen to gather this information.

14. An apparatus as described in claim 4 when integrated with devices traditionally outfitted with a screen such as a CRT, LCD, or plasma, where the screen can be replaced with the device described in these claims to make a screen less unit.

15. An apparatus as described in claim 4 shaped to fit a particular body feature such as the human ear or be attached to span across both ears, be designed in the form of a necklace, a watch, keychain, or as part of a uniform attached to a pair of glasses, sun-glasses, goggles, helmet visor or other contraption used to correct or protect human vision.

16. An apparatus as described in claim 4 designed into a capsule or other apparatus that is particularly constructed for insertion into the human body. Typical locations on the human body for such a product would be inside the ear, under the skin of the human head, behind the skin of the face, inside the nasal or sinus cavity, within and close to the cheekbone, in the throat, near the larynx, or any other suitable place on the body.

17. An apparatus as described in claim 4 where the apparatus in particular is a clock with or without the capability of producing one or more alarms, where speech is used to set time, set alarm time, enable, disable, snooze and silence alarms.

18. An apparatus as described in claim 4 when particularly used in a wall thermostat, a home security or an alarm system, when used to read back temperature and other parameters using audible speech, a kitchen appliance, such as a microwave, a toaster, a coffeemaker, a bread maker, a refrigerator, or other kitchen appliance, where human speech is used to set time, set cooking power, set cooking time, start and stop cooking, and enter special programs or cooking cycles.

19. An apparatus as described in claim 4 specifically used in devices for handicapped and disabled people, including operating and navigating wheel chairs and other mobility devices, respirators, automobiles, motion computers, assisted living devices, etc. where the ability to communicate with a device through human speech and audible speech feedback eliminates the need for using hands when operating equipment, and the need for visual feedback.

20. An apparatus as described in claim 4 where a device being added voice control feature is a camera, a video recorder, data, or sound recorder, where voice commands are used to control such features as start or stop recording, changing settings, requesting status information on battery life, remaining recording media time, or other status or control.
